(19) United States
(12) Patent Application Publication
(10) Pub. No.: US 2024/0326375 A1
(43) Pub. Date: Oct. 3, 2024

(54) SYSTEMS AND METHODS FOR REINFORCING HIGH-TEMPERATURE, HIGH PRESSURE PIPE

(71) Applicant: Next Composite Solutions, Inc., Edwardsville, IL (US)

(72) Inventors: John O’Leary, Glen Carbon, IL (US); George Mathes, Edwardsville, IL (US)

(21) Appl. No.: 18/579,076

(22) PCT Filed: Jul. 13, 2022
(86) PCT No.: PCT/US2022/073674

§ 371 Date: Jan. 12, 2024

Related U.S. Application Data
(60) Provisional application No. 63/222,175, filed on Jul. 15, 2021.

(51) Int. Cl. B32B 5/02; B32B 1/08; B32B 37/24; B32B 38/00

(52) U.S. Cl. CPC B32B 5/024; B32B 1/08; B32B 37/24; B32B 2037/243; B32B 2038/0076; B32B 2255/26; B32B 2262/106; B32B 2262/128; B32B 2305/08; B32B 2307/718; B32B 2363/00; B32B 2597/00

(57) ABSTRACT

Provided herein are systems and methods for reinforcing a high-temperature, high pressure pipe. In one embodiment, a reinforcing material (e.g., carbon fiber) and an epoxy resin composition are applied to an inner or outer surface of a pipe. The epoxy resin composition is cured in situ, thereby forming a cured composite material attached to the inner or outer surface of the pipe. The cured composite material comprises a cured epoxy resin composition having a Tg of at least about 250° F. (121.1° C.).

### CROSS-REFERENCE TO RELATED APPLICATION

The present application claims priority to U.S. Provisional Patent Application Ser. No. 63/222,175, filed Jul. 15, 2021, the entire contents of which are herein incorporated by reference.

### FIELD

The present disclosure is generally directed to systems and methods for reinforcing high-pressure, high-temperature pipe. For example, the present disclosure provides for the formation of a composite material on the outer surface of a pipe, wherein the composite material comprises a cured epoxy resin having a glass transition temperature (Tg) of at least about 250° F. (121.1° C.).

### BACKGROUND

Piping is an integral component of nearly every modern industrial process. In many industries, particularly energy generation and chemical/petrochemical production, piping systems must accommodate the transportation of components under high pressure, high temperature, or both. Designing and maintaining process piping that can accommodate high temperatures and pressures is an ongoing challenge. Adding to the challenges, the components transported within the piping are often hazardous (e.g., caustic or acidic) for reasons independent of their high pressure and temperature.

Like all industrial equipment, process piping inevitably degrades over time. Unfortunately, traditional methods of repairing high pressure, high temperature piping are both difficult and expensive. In many facilities, taking a process offline to replace a damaged section of pipe is highly undesirable, due to the financial losses incurred as a result of the downtime. It is therefore desirable to use methods of reinforcing the pipe that can be applied in situ to the pipe's outer surface, without affecting the underlying industrial process.

Composite materials, particularly those comprising carbon fibers and a polymeric binder, have been increasingly used in recent years for the repair of process piping. Unfortunately, such composite materials often have relatively low heat resistance that makes them unsuitable for use in high temperature repairs.

There is therefore a need in the industry for a method of reinforcing industrial process piping that can be applied in situ and is suitable for use with high temperature, high pressure processes.

### SUMMARY

Provided herein is a method of reinforcing a pipe having an inner surface, the method comprising combining a curable epoxy resin composition and a curing agent, thereby forming an epoxy reaction mixture; applying a first layer of epoxy reaction mixture to the inner surface of the pipe; applying a reinforcing material over at least a portion of the first layer; applying a second layer of the epoxy reaction mixture over at least a portion of the reinforcing material; and allowing the epoxy reaction mixture to cure in situ, thereby forming a cured composite material attached to the inner surface of the pipe, wherein the cured composite material comprises a cured epoxy resin composition having a Tg of at least about 250° F. (121.1° C.).

Also provided herein is a method of reinforcing a pipe having an inner surface, the method comprising combining a curable epoxy resin composition and a curing agent, thereby forming an epoxy reaction mixture, applying the epoxy reaction mixture over at least a portion of a reinforcing material in a sufficient amount that the reinforcing material becomes saturated with the epoxy reaction mixture, applying the saturated reinforcing material to at least a portion of the inner surface of the pipe, and allowing the epoxy reaction mixture to cure in situ, thereby forming a cured composite material attached to the inner surface of the pipe, wherein the cured composite material comprises a cured epoxy resin composition having a Tg of at least about 250° F. (121.1° C.).

Provided herein is a method of reinforcing a pipe having an outer surface, the method comprising combining a curable epoxy resin composition and a curing agent, thereby forming an epoxy reaction mixture; applying a first layer of epoxy reaction mixture to the outer surface of the pipe; applying a reinforcing material over at least a portion of the first layer; applying a second layer of the epoxy reaction mixture over at least a portion of the reinforcing material; and allowing the epoxy reaction mixture to cure in situ, thereby forming a cured composite material attached to the outer surface of the pipe, wherein the cured composite material comprises a cured epoxy resin composition having a Tg of at least about 250° F. (121.1° C.).

Also provided herein is a method of reinforcing a pipe having an outer surface, the method comprising combining a curable epoxy resin composition and a curing agent, thereby forming an epoxy reaction mixture, applying the epoxy reaction mixture over at least a portion of a reinforcing material in a sufficient amount that the reinforcing material becomes saturated with the epoxy reaction mixture, applying the saturated reinforcing material to at least a portion of the outer surface of the pipe, and allowing the epoxy reaction mixture to cure in situ, thereby forming a cured composite material attached to the outer surface of the pipe, wherein the cured composite material comprises a cured epoxy resin composition having a Tg of at least about 250° F. (121.1° C.).

Also provided herein is a reinforced pipe formed according to a method as disclosed herein.

Also provided herein is a system for reinforcing the inner surface of a pipe comprising a curable epoxy resin composition comprises an epoxy phenolic resin; a curing agent comprising a diamine; and a carbon fiber material configured for application to the inner surface of a pipe; wherein the curable epoxy resin composition and the curing agent are present in a ratio that, when combined, will form a cured epoxy resin composition having a Tg of at least about 250° F. (121.1° C.).

Also provided herein is a system for reinforcing the outer surface of a pipe comprising a curable epoxy resin composition comprises an epoxy phenolic resin; a curing agent comprising a diamine; and a carbon fiber material configured for application to the outer surface of a pipe; wherein the curable epoxy resin composition and the curing agent are present in a ratio that, when combined, will form a cured epoxy resin composition having a Tg of at least about 250° F. (121.1° C.).

These and other aspects of the present disclosure are described in further detail below.

### DESCRIPTION OF THE FIGURES

FIG. 1 is a cross-sectional view of a high-pressure, high-temperature pipe in accordance with an embodiment of the present disclosure.

FIG. 2 is a perspective view of a reinforced pipe in accordance with an embodiment of the present disclosure.

Corresponding reference characters indicate corresponding parts throughout the drawings.

### DETAILED DESCRIPTION

Provided herein are systems and methods for reinforcing high-pressure, high-temperature pipe. In preferred embodiments, the present disclosure provides for the formation of a cured composite material on the outer surface of a pipe, wherein the cured composite material comprises a cured epoxy resin having a glass transition temperature (Tg) of at least about 250° F. (121.1° C.).

### High Pressure, High-Temperature Pipe

The methods provided herein may be used to provide structural reinforcement to the exterior surfaces of piping, including industrial process piping. For example, the piping may be used to transport components under high temperature (e.g., temperatures in excess of 150° F. (65.6° C.), 155° F. (68.3° C.), 170° F. (76.7° C.), 200° F. (93.3° C.), 215° F. (101.7° C.), 250° F. (121.1° C.), 300° F. (148.9° C.), 350° F. (176.7° C.), 400° F. (204.4° C.), 450° F. (232.2° C.), 500° F. (260° C.), 550° F. (287.8° C.), or even 600° F. (315.6° C.)) and/or high pressure (e.g., pressures in excess of 50 pounds per square inch (“PSI”) (344.7 kPa), 100 PSI (689.5 kPa), 200 PSI (1379.0 kPa), 300 PSI (2068.4 kPa), 400 PSI (2757.9 kPa), or even 500 PSI (3447.4 kPa)). Those skilled in the art will appreciate that there are a number of conditions wherein a pipe will require structural reinforcement. For example, the methods provided herein may be used to restore or increase a pressure or gravity boundary within a compromised pipe.

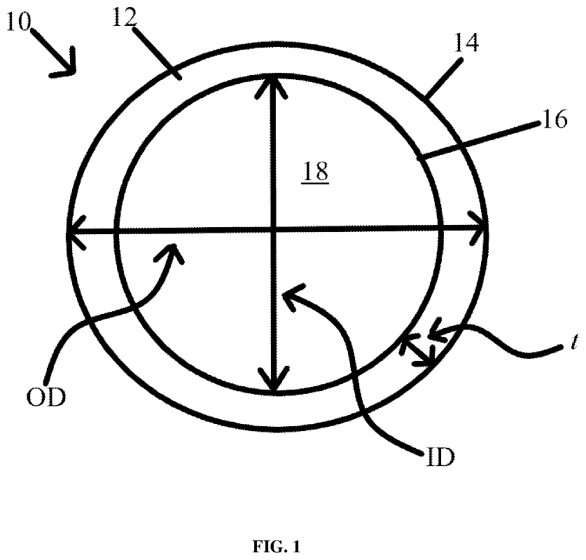

A “pipe” is an elongated, tube-shaped structure having an annular wall. As shown in FIG. 1, the annular wall 12 defines an annular passageway 18 extending through the pipe 10. The annular wall 12 has two opposing surfaces, including an outer surface 14 and an inner surface 16. Those skilled in the art will appreciate that the methods provided herein may be used to reinforce any type of vessel that is designed or used to contain a pressurized environment, and that references to “pipe” herein are merely representative examples of the uses to which the methods may be applied and should not be interpreted in a limiting sense.

A “high-pressure, high-temperature pipe” is a pipe that may be used to transport components at (i) a pressure of at least about 50 PSI (344.7 kPa), or at least about 100 PSI (689.5 kPa), or at least about 200 PSI (1379.0 kPa), or at least about 300 PSI (2068.4 kPa), or at least about 400 PSI (2757.9 kPa), or at least about 500 PSI (3447.4 kPa) and (ii) a temperature of at least about 150° F. (65.6° C.), or at least about 155° F. (68.3° C.), or at least about 170° F. (76.7° C.), or at least about 200° F. (93.3° C.), or at least about 215° F. (101.7° C.), or at least about 250° F. (121.1° C.), or at least about 300° F. (148.9° C.), or at least about 350° F. (176.7° C.), or at least about 400° F. (204.4° C.), or at least about 450° F. (65.6° C.), or at least about 500° F. (260° C.), or at least about 550° F. (287.8° C.), or at least about 600° F. (315.6° C.). In an embodiment, the high-pressure, high-temperature pipe 10 may be used to transport components at (i) a pressure of from about 50 PSI (344.7 kPa) to about 500 PSI (3447.4 kPa), or from about 50 PSI (344.7 kPa) to about 300 PSI (2068.4 kPa), or from about 50 PSI (344.7 kPa) to about 100 PSI (689.5 kPa) and (ii) a temperature from about 150° F. (65.6° C.) to about 600° F. (315.6° C.), or from about 150° F. (65.6° C.) to about 300° F. (148.9° C.), or from about 155° F. (68.3° C.) to about 600° F. (315.6° C.), or from about 155° F. (68.3° C.) to about 300° F. (148.9° C.), or from about 155° F. (68.3° C.) to about 200° F. (93.3° C.), or from about 155° F. (68.3° C.) to about 170° F. (76.7° C.), or from about 215° F. (101.7° C.) to about 400° F. (204.4° C.).

In an embodiment, the high-pressure, high-temperature pipe 10 is a carbon steel pipe.

The high-pressure, high-temperature pipe 10 has an inner diameter, ID, as shown in FIG. 1. In an embodiment, the high-pressure, high-temperature pipe 10 has an inner diameter, ID, of at least about 1 inch (“in”) (2.54 cm) or at least about 5 in (12.7 cm), or at least about 6 in (15.2 cm). In another embodiment, the high-pressure, high-temperature pipe has an inner diameter, ID, of from about 1 in (2.54 cm), or about 2 in (5.08 cm), or about 5 in (12.7 cm), or about 6 in (15.2 cm) to about 7 in (17.8 cm), or about 9 in (22.9 cm), or about 10 in (25.4 cm), or about 12 in (30.5 cm), or about 15 in (38.1 cm), or about 20 in (50.8 cm). In a further embodiment, the high-pressure, high-temperature pipe has an inner diameter, ID, of from about 1 in (2.54 cm) to about 20 in (50.8 cm), or from about 2 in (5.08 cm) to about 10 in (25.4 cm), or from about 5 in (12.7 cm) to about 6 in (15.2 cm), or from about 6 in (15.2 cm) to about 7 in (17.8 cm).

The high-pressure, high-temperature pipe 10 has an outer diameter, OD, as shown in FIG. 1. In an embodiment, the high-temperature pipe 10 has an outer diameter, OD, of at least about 1.5 in (3.81 cm), or at least about 5.5 in (14.0 cm), or at least about 6 in (15.2 cm), or at least about 6.5 in (16.5 cm), or at least about 6.7 in (17.0 cm). In another embodiment, the high-temperature pipe 10 has an outer diameter, OD, of from about 1.5 in (3.81 cm), or about 2.5 in (6.35 cm), or about 5.5 in (14.0 cm), or about 6 in (15.2 cm), or about 6.5 in (16.5 cm), or about 6.7 in (17.0 cm) to about 7.5 in (19.1 cm), or about 10 in (25.4 cm), or about 11 in (27.9 cm), or about 13 in (33.0 cm), or about 16 in (40.6 cm), or about 21 in (53.3 cm), or about 25 in (63.5 cm). In a further embodiment, the high-temperature pipe 10 has an outer diameter, OD, of from about 1.5 in (3.81 cm) to about 25 in (63.5 cm), or from about 2.5 in (6.35 cm) to 11 in (27.9 cm), or from about 5.5 in (14.0 cm) to about 7 in (17.8 cm), or from about 6.5 in (16.5 cm) to about 7.5 in (19.1 cm).

The annular wall 12 of the high-pressure, high-temperature pipe 10 has a thickness, t, as shown in FIG. 1. In an embodiment, the annular wall 12 of the high-pressure, high-temperature pipe 10 has a thickness, t, of at least about 0.20 in (0.51 cm), or at least about 0.30 in (0.76 cm), or at least about 0.35 in (0.89 cm). In another embodiment, the annular wall 12 of the high-pressure, high-temperature pipe 10 has a thickness, t, of from about 0.20 in (0.51 cm), or about 0.25 in (0.64 cm), or about 0.30 in (0.76 cm), or about 0.35 in (0.89 cm), or about 0.37 in (0.94 cm) to about 0.38 in (0.97 cm), or about 0.40 in (1.0 cm), or about 0.50 in (1.3 cm), or about 0.75 in (1.9 cm), or about 1.0 in (2.5 cm), or about 1.5 in (3.8 cm), or about 3 in (7.6 cm), or about 5 in (12.7 cm), or about 10 in (25.4 cm). In a further embodiment, the annular wall 12 of the high-pressure, high-temperature pipe 10 has a thickness, t, of from about 0.20 in (0.51 cm) to about 10 in (25.4 cm), or from about 0.20 in (0.51 cm) to about 5 in (12.7 cm), or from about 0.20 in (0.51 cm) to about 3 in (7.6 cm), or from about 0.20 in (0.51 cm) to about 1 in (2.5 cm), or from about 0.30 in (0.76 cm) to about 0.50 in (1.3 cm), or from about 0.37 in (0.94 cm) to about 0.38 in (0.97 cm).

In an embodiment, the high-pressure, high-temperature pipe 10 has a pipe run of at least about 500 feet (“ft”) (152.4 m), or at least about 1,000 ft (304.8 m), or at least about 1,100 ft (335.3 m). In another embodiment, the high-pressure, high-temperature pipe 10 has a pipe run of from about 500 ft (152.4 m) to about 10,000 ft (3048 m), or from about 500 ft (152.4 m) to about 5,000 ft (1524 m), or from about 500 ft (152.4 m) to about 2,000 ft (609.6 m), or from about 1,000 ft (304.8 m) to about 2,000 ft (609.6 m).

In an embodiment, the outer surface 14 of the high-pressure, high-temperature pipe 10 is cleaned and dried prior to the application of the epoxy reaction mixture. For example, all surface paint, mill scale, oil, rust, or other contaminants are removed from the outer surface 14 of the high-pressure, high-temperature pipe 10. In an embodiment, the outer surface 14 of the high-pressure, high-temperature pipe 10 is cleaned via solvent wiping. In a further embodiment, the outer surface 14 of the high-pressure, high-temperature pipe 10 is cleaned within about 24 hours of the application of the epoxy reaction mixture.

In an embodiment, the outer surface 14 of the high-pressure, high-temperature pipe 10 is treated to achieve a clean surface with a roughened texture, such as by mechanical grinding or any other suitable treatment known in the art, whether by mechanical or chemical means.

In an embodiment, the outer surface 14 of the high-pressure, high-temperature pipe 10 is void of, or substantially void of fins, sharp edges, and protrusions. Without being bound to any particular theory, it is believed that fins, sharp edges, and protrusions may damage the reinforcing material and/or cause voids between the outer surface 14 and the cured composite material. It is understood, however, that some embodiments of the present disclosure may include piper outer surfaces 14 having fins, sharp edges, and/or protrusions.

In an embodiment, the high-pressure, high-temperature pipe 10 has one, some, or all of the following properties:
(a) may be used to transport components at a pressure of from about 50 PSI (344.7 kPa) to about 500 PSI (3447.4 kPa), or from about 50 PSI (344.7 kPa) to about 300 PSI (2068.4 kPa), or from about 50 PSI (344.7 kPa) to about 100 PSI (689.5 kPa); and/or
(b) may be used to transport components at a temperature from about 150° F. (65.6° C.) to about 600° F. (315.6° C.), or from about 150° F. (65.6° C.) to about 300° F. (148.9° C.), or from about 155° F. (68.3° C.) to about 600° F. (315.6° C.), or from about 155° F. (68.3° C.) to about 300° F. (148.9° C.), or from about 155° F. (68.3° C.) to about 200° F. (93.3° C.), or from about 155° F. (68.3° C.) to about 170° F. (76.7° C.), or from about 215° F. (101.7° C.) to about 400° F. (204.4° C.); and/or
(c) is a carbon steel pipe; and/or
(d) has an inner diameter, ID, of from about 1 in (2.5 cm) to about 20 in (50.8 cm), or from about 2 in (5.1 cm) to about 10 in (25.4 cm), or from about 5 in (12.7 cm) to about 6 in (15.2 cm), or from about 6 in (15.2 cm) to about 7 in (17.8 cm); and/or
(e) has an outer diameter, OD, of from about 1.5 in (3.8 cm) to about 25 in (63.5 cm), or from about 2.5 in (6.4 cm) to about 11 in (27.9 cm), or from about 5.5 in (14.0 cm) to about 7 in (17.8 cm), or from about 6.5 in (16.5 cm) to about 7.5 in (19.1 cm); and/or
(f) has an annular wall 12 with a thickness, t, of from about 0.20 in (0.51 cm) to about 10 in (25.4 cm), or from about 0.20 in (0.51 cm) to about 5 in (12.7 cm), or from about 0.20 in (0.51 cm) to about 3 in (7.6 cm), or from about 0.20 in (0.51 cm) to about 1 in (2.5 cm), or from about 0.30 in (0.76 cm) to about 0.50 in (1.3 cm), or from about 0.37 in (0.94 cm) to about 0.38 in (0.97 cm); and/or
(g) has a pipe run of from about 500 ft (152.4 m) to about 10,000 ft (3048 m), or from about 500 ft (152.4 m) to about 5,000 ft (1524 m), or from about 500 ft (152.4 m) to about 2,000 ft (609.6 m), or from about 1,000 ft (304.8 m) to about 2,000 ft (609.6 m); and/or
(h) has an outer surface 14 that is void of, or substantially void of surface paint, mill scale, oil, rust, or other contaminants; and/or
(i) has an outer surface 14 that has been treated to achieve a clean surface with a roughened texture, such as by mechanical grinding; and/or
(j) has an outer surface 14 that has been cleaned via solvent wiping.

### Curable Epoxy Resin Composition

The methods provided herein may utilize a curable epoxy resin composition. The curable epoxy resin composition may be combined with a curing agent, thereby forming an epoxy reaction mixture. When the curing reaction is complete, the cured epoxy resin composition has a Tg of at least about 250° F. (121.1° C.).

In one embodiment, the epoxy reaction mixture comprises, consists essentially of, or consists of, (i) the curable epoxy resin composition and (ii) the curing agent.

As used herein, “curable” and similar terms indicate that the epoxy resin composition (1) is not cured or crosslinked and has not been subjected or exposed to treatment that has induced substantial crosslinking, and (2) is capable of being cured or substantially crosslinked upon subjection or exposure to such treatment (e.g., being contacted with a curing agent under appropriate conditions).

As used herein, the term “curable epoxy resin composition” means a composition comprising at least one epoxy resin compound possessing one or more vicinal epoxy groups per molecule, i.e. at least one 1,2-epoxy group per molecule. In general, the epoxy resin compound may be a saturated or unsaturated aliphatic, cycloaliphatic, aromatic or heterocyclic compound which possesses at least one 1,2-epoxy group. Such compound can be substituted, if desired, with one or more non-interfering substituents, such as halogen atoms, hydroxy groups, ether radicals, lower alkyls and the like.

The epoxy resins useful in the present invention may include monoepoxides, diepoxides, polyepoxides or mixtures thereof. Illustrative compounds useful in the practice of the instant invention are described in the Handbook of Epoxy Resins by H. E. Lee and K. Neville published in 1967 by McGraw-Hill, New York; and U.S. Pat. No. 4,066,628, both of which are incorporated herein by reference.

The epoxy resins useful in the present invention may include, for example, the glycidyl polyethers of polyhydric phenols and polyhydric alcohols. As an illustration of the present invention, examples of known epoxy resins that may be used in the present invention, include, for example, the diglycidyl ethers of resorcinol, catechol, hydroquinone, bisphenol, bisphenol A, bisphenol AP (1,1-bis(4-hydroxylphenyl)-1-phenyl ethane), bisphenol F, bisphenol K, tetrabromobisphenol A, phenol-formaldehyde novolac resins, alkyl substituted phenol-formaldehyde resins, phenol-hydroxy benzaldehyde resins, cresol-hydroxy benzaldehyde resins, dicyclopentadiene-phenol resins, dicyclopentadiene-substituted phenol resins tetramethylbiphenol, tetramethyl-tetrabromobiphenol, tetramethyltribromobiphenol, tetrachlorobisphenol A; and any combination thereof.

In preferred embodiments, the curable epoxy resin composition comprises an epoxy phenolic resin. In a particularly preferred embodiment, the curable epoxy resin composition comprises bisphenol A diglycidyl ether resin (CAS 25068-38-6). Bisphenol A diglycidyl ether resin is an epoxy phenolic resin having the following Structure A:

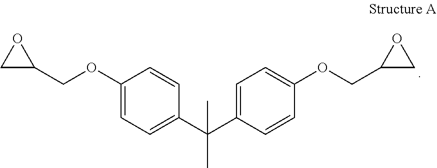 [SMILES: CC(C)(c1ccc(OCC2CO2)cc1)c1ccc(OCC2CO2)cc1]

In an embodiment, the curable epoxy resin composition comprises, consists essentially of, or consists of bisphenol A diglycidyl ether resin and butyl glycidyl ether (CAS 2426 Aug. 6). In another embodiment, the curable epoxy resin composition comprises, consists essentially of, or consists of (i) greater than about 50 wt % bisphenol A diglycidyl ether resin and (ii) from greater than about 0 wt % to less than about 50 wt % butyl glycidyl ether, based on the total weight of the curable epoxy resin composition. In a further embodiment, the curable epoxy resin composition comprises, consists essentially of, or consists of (i) from about 60 wt % to about 95 wt %, or from about 70 wt % to about 95 wt %, or from about 80 wt % to about 95 wt %, or from about 80 wt % to about 90 wt %, or from about 90 wt % to about 95 wt % bisphenol A diglycidyl ether resin and (ii) from about 5 wt % to about 40 wt %, or from about 5 wt % to about 30 wt %, or from about 20 wt % to about 5 wt %, or from about 10 wt % to about 20 wt %, or from about 5 wt % to about 10 wt % butyl glycidyl ether, based on the total weight of the curable epoxy resin composition.

In an embodiment, the curable epoxy resin composition has a density of from about 1.00 grams per cubic centimeter (g/cc or g/cm³), or about 1.10 g/cc, or about 1.13 g/cc to about 1.15 g/cc, or about 1.20 g/cc, or about 1.30 g/cc, or about 1.50 g/cc. In another embodiment, the curable epoxy resin composition has a density of from about 1.00 g/cc to about 1.50 g/cc, or from about 1.10 g/cc to about 1.20 g/cc, or from about 1.10 g/cc to about 1.15 g/cc. Density is measured in accordance with ASTM D792, Method B.

In an embodiment, the curable epoxy resin composition has a flash point of at least about 70° C., or at least about 75° C., or at least about 78° C. In another embodiment, the curable epoxy resin composition has a flash point of from about 70° C. to about 100° C., or from about 70° C. to about 80° C., or from about 75° C. to about 80° C., or from about 78° C. to about 80° C. “Flash point” and like terms refer to the lowest temperature at which a volatile liquid can vaporize to form an ignitable mixture in air but will not continue to burn (compare to fire point). Flash point is measured in accordance with ASTM D 3278.

In an embodiment, the curable epoxy resin composition is void of styrene, or is substantially void of styrene. In another embodiment, the curable epoxy resin composition contains less than about 5 wt %, or less than about 2 wt %, or less than about 1 wt %, or less than about 0.5 wt %, or less than about 0.1 wt %, or 0 wt % styrene, based on the total weight of the curable epoxy resin composition.

In an embodiment, the curable epoxy resin composition is void of filler, or is substantially void of filler. In other words, the curable epoxy resin composition is void of filler such as clay, silica, and flake.

In an embodiment, the curable epoxy resin composition has one, some, or all of the following properties:
(a) a density of from about 1.00 g/cc to about 1.50 g/cc, or from about 1.10 g/cc to about 1.20 g/cc, or from about 1.10 g/cc to about 1.15 g/cc; and/or
(b) a flash point of from about 70° C. to about 100° C., or from about 70° C. to about 80° C., or from about 75° C. to about 80° C., or from about 78° C. to about 80° C.; and/or
(c) is void of styrene, or is substantially void of styrene; and/or
(d) is void of filler, or is substantially void of filler (e.g., clay, silica, and flake).

In an embodiment, the curable epoxy resin composition comprises, consists essentially of, or consists of (i) from about 60 wt % to about 95 wt %, or from about 70 wt % to about 95 wt %, or from about 80 wt % to about 95 wt %, or from about 80 wt % to about 90 wt %, or from about 90 wt % to about 95 wt % bisphenol A diglycidyl ether resin and (ii) from about 5 wt % to about 40 wt %, or from about 5 wt % to about 30 wt %, or from about 20 wt % to about 5 wt %, or from about 10 wt % to about 20 wt %, or from about 5 wt % to about 10 wt % butyl glycidyl ether, based on the total weight of the curable epoxy resin composition, and the curable epoxy resin composition has one, some, or all of the following properties:
(a) a density of from about 1.00 g/cc to about 1.50 g/cc, or from about 1.10 g/cc to about 1.20 g/cc, or from about 1.10 g/cc to about 1.15 g/cc; and/or
(b) a flash point of from about 70° C. to about 100° C., or from about 70° C. to about 80° C., or from about 75° C. to about 80° C., or from about 78° C. to about 80° C.; and/or
(c) is void of styrene, or is substantially void of styrene; and/or
(d) is void of filler, or is substantially void of filler (e.g., clay, silica, and flake).

### Curing Agent

Generally, the curing agent may comprise any compound known in the art to be useful for curing epoxy resin compositions. Non-limiting examples of curing agents known in the art include amino resins, anhydrides, carboxylic acids, amine compounds, phenolic compounds, alcohols, and mixtures thereof.

In an embodiment, the curing agent comprises an amine compound. An “amine compound” is a compound containing an amine group. An “amine” refers to the group: —NR¹R²R³, where each of R¹, R² and R² is independently selected from the group consisting of hydrogen, alkyl, substituted alkyl, cycloalkyl, substituted cycloalkyl, heterocycloalkyl, substituted heterocycloalkyl, aryl (including pyridines), substituted aryl, heteroaryl, substituted heteroaryl, alkoxy, aryloxy, silyl and combinations thereof. In an embodiment, the curing agent is a diamine. Nonlimiting examples of suitable diamines include isophorone diamine (CAS 2855-13-2), 2,2,4-trimethyl-1,6-hexanediamine (CAS 25620-58-0), and combinations thereof.

In an embodiment, the curing agent comprises a phenolic compound. A “phenolic compound” is a compound containing a phenolic group. A “phenolic group” refers to the group: —O—C₆H₅. A nonlimiting example of a suitable phenolic compound is phenol (CAS 108-95-2).

In an embodiment, the curing agent comprises an alcohol. An “alcohol” is a compound having an —OH group bound to a saturated carbon atom. A nonlimiting example of a suitable alcohol is benzyl alcohol (CAS 100-51-6).

In an embodiment, the curing agent comprises a peroxide. A “peroxide” is a compound in which two oxygen atoms are linked together by a single covalent bond. Non-limiting examples of peroxides include benzoyl peroxide, dichlorobenzoyl peroxide, dicumyl peroxide, tertiary butyl peroxide, lauroyl peroxide, methyl ethyl ketone peroxide, diacyl peroxides, peroxyesters, alkyl peroxides, hydroperoxides (e.g., cumene hydroperoxide), peroxy dicarbonates, and mixtures thereof. For example, the curing agent may be selected from the group consisting of methyl ethyl ketone peroxide and cumene hydroperoxide. In particularly preferred embodiments, the curing agent is methyl ethyl ketone peroxide.

In an embodiment, the curing agent is void of peroxide, or is substantially void of peroxide. For example, the curing agent is void of peroxides such as methyl ethyl ketone peroxide (“MEKP”) and cumyl hydroperoxide (“CUHP”).

In an embodiment, the curing agent comprises, consists essentially of, or consists of an amine compound, a phenolic compound, and an alcohol. In another embodiment, the curing agent comprises, consists essentially of, or consists of (i) from about 30 wt % to about 60 wt %, or from about 40 wt % to about 60 wt %, or from about 40 wt % to about 55 wt % of an amine compound, (ii) from about 1 wt % to about 10 wt %, or from about 1 wt % to about 5 wt % of a phenolic compound, and (iii) from about 30 wt % to about 60 wt %, or from about 40 wt % to about 55 wt %, or from about 40 wt % to about 50 wt % of an alcohol, based on the total weight of the curing agent.

In an embodiment, the curing agent comprises, consists essentially of, or consists of isophorone diamine, 2,2,4-trimethyl-1,6-hexanediamine, phenol, and benzyl alcohol. In another embodiment, the curing agent comprises, consists essentially of, or consists of (i) from about 30 wt % to about 60 wt %, or from about 40 wt % to about 50 wt % isophorone diamine, (ii) from about 0.1 wt % to about 10 wt %, or from about 1 wt % to about 5 wt % 2,2,4-trimethyl-1,6-hexanediamine, (iii) from about 1 wt % to about 10 wt %, or from an 1 wt % to about 5 wt % phenol, and (iv) from about 30 wt % to about 60 wt %, or from about 40 wt % to about 50 wt % benzyl alcohol.

In an embodiment, the curing agent has a density of from about 0.90 g/cc, or about 0.95 g/cc, or about 1.00 g/cc to about 1.01 g/cc, or about 1.05 g/cc, or about 1.10 g/cc, or about 1.20 g/cc. In another embodiment, the curing agent has a density of from about 0.90 g/cc to about 1.20 g/cc, or from about 0.90 g/cc to about 1.10 g/cc, or from about 1.00 g/cc to about 1.05 g/cc. Density is measured in accordance with ASTM D792, Method B.

In an embodiment, the curing agent has a flash point of at least about 70° C., or at least about 90° C., or at least about 100° C., or at least about 105° C., or at least about 106° C. In another embodiment, the curing agent has a flash point of from about 70° C. to about 150° C., or from about 80° C. to about 120° C., or from about 100° C. to about 120° C., or from about 105° C. to about 120° C., or from about 105° C. to about 110° C. Flash point is measured in accordance with ASTM D 3278.

In an embodiment, the curing agent has one, some, or all of the following properties:
(a) a density of from about 0.90 g/cc to about 1.20 g/cc, or from about 0.90 g/cc to about 1.10 g/cc, or from about 1.00 g/cc to about 1.05 g/cc; and/or
(b) a flash point of from about 70° C. to about 150° C., or from about 80° C. to about 120° C., or from about 100° C. to about 120° C., or from about 105° C. to about 120° C., or from about 105° C. to about 110° C.; and/or
(c) is void of peroxides (e.g., MEKP and CUHP).

In an embodiment, the curing agent is part of a curing agent composition that comprises, consists essentially of, or consists of (i) from about 30 wt % to about 60 wt %, or from about 40 wt % to about 50 wt % isophorone diamine, (ii) from about 0.1 wt % to about 10 wt %, or from about 1 wt % to about 5 wt % 2,2,4-trimethyl-1,6-hexanediamine, (iii) from about 1 wt % to about 10 wt %, or from about 1 wt % to about 5 wt % phenol, (iv) from about 30 wt % to about 60 wt %, or from about 40 wt % to about 50 wt % benzyl alcohol, and (v) from about 1 wt % to about 10 wt %, or from about 5 wt % to about 10 wt % epoxy resin (e.g., an epoxy phenolic resin such as bisphenol A diglycidyl ether resin). In a further embodiment, the curing agent composition has one, some, or all of the following properties:
(a) a density of from about 0.90 g/cc to about 1.20 g/cc, or from about 0.90 g/cc to about 1.10 g/cc, or from about 1.00 g/cc to about 1.05 g/cc; and/or
(b) a flash point of from about 70° C. to about 150° C., or from about 80° C. to about 120° C., or from about 100° C. to about 120° C., or from about 105° C. to about 120° C., or from about 105° C. to about 110° C.; and/or
(c) is void of, or substantially void of, peroxides (e.g., MEKP and CUHP).

### Optional Components

The epoxy reaction mixture provided herein may further comprise one or more optional components.

The epoxy reaction mixture may further comprise an aggregate material. A non-limiting example of an aggregate material is fumed silica. For example, an epoxy reaction mixture as provided herein may be combined with fumed silica prior to being applied to the surface of a pipe or reinforcing material. Without being bound to a particular theory, the aggregate material (e.g., fumed silica) provides additional surface area that promotes the mechanical adhesion of the epoxy reaction mixture to the surface of the pipe or reinforcing material.

When an aggregate material is present, the volumetric ratio of the epoxy reaction mixture to the aggregate material is typically at least about 1:1, for example from about 1:1 to about 8:1, from about 1:1 to about 5:1, from about 1:1 to about 4:1, from about 1:1 to about 3:1, from about 1:1 to about 2:1, from about 1:1 to about 1.5:1, or from about 1:1 to about 1.25:1.

In another embodiment, the epoxy reaction mixture is void of, or substantially void of, aggregate material.

### Epoxy Reaction Mixture

In the methods provided herein, the epoxy reaction mixture comprises a curable epoxy resin composition and a curing agent as described herein.

The curable epoxy resin composition and a curing agent are combined to form the epoxy reaction mixture. Nonlimiting examples of suitable methods of combining the curable epoxy resin composition and curing agent include mixing, blending, and compounding. In an embodiment, the curable epoxy resin composition and curing agent are mixed using a mechanical drill equipped with a Jiffy mixer head. The curable epoxy resin composition and curing agent are combined when each is at room temperature (i.e., from about 60° F. (15.6° C.) to about 85° F. (29.4° C.)). The curable epoxy resin composition and curing agent are combined at ambient conditions, or at an air and surface temperature of from about 45° F. (7.2° C.) to about 100° F. (37.8° C.), and at a dew point that is within 5° F. (2.8° C.) of the air and surface temperature.

The ratio of the curing agent to the curable epoxy resin composition in the epoxy reaction mixture should be selected to maximize the glass transition temperature (Tg) of the cured resin, while retaining a gel time sufficient to accommodate use of the reaction mixture in the pipe reinforcement methods described herein. A lower ratio of curing agent to epoxy resin will result in a lower Tg, but a longer gel time; conversely, a higher ratio of curing agent to epoxy resin will result in a higher Tg, but a shorter gel time. Typically, the volume ratio of curable epoxy resin composition to curing agent in the epoxy reaction mixture is from about 1:1 to about 20:1, more typically from about 2:1 to about 15:1, more typically from about 2:1 to about 10:1, and more typically from about 2:1 to about 4:1. In an embodiment, the volume ratio of curable epoxy resin composition to curing agent in the epoxy reaction mixture is 2:1.

A key aspect of the present invention is the selection of a curable epoxy resin composition and a curing agent that, when combined, will form a cured epoxy resin having a Tg of at least about 250° F. (121.1° C.). Preferably, the cured epoxy resin has a Tg of at least about 250° F. (121.1° C.), or at least about 260° F. (126.7° C.), at least about 270° F. (132.2° C.), or even higher. In an embodiment, the cured epoxy resin has a Tg of from about 250° F. (121.1° C.) to about 400° F. (204.4° C.), or from about 250° F. (121.1° C.) to less than about 400° F. (204.4° C.), or from about 250° F. (121.1° C.) to about 350° F. (176.7° C.), or from about 250° F. (121.1° C.) to about 300° F. (148.9° C.), or from about 260° F. (126.7° C.) to about 300° F. (148.9° C.), or from about 260° F. (126.7° C.) to about 280° F. (137.8° C.), or from about 260° F. (126.7° C.) to about 270°) F. (132.2° C.).

Without being bound to a particular theory, it is believed that a curing reaction that is more strongly exothermic results in a cured epoxy resin having a correspondingly higher Tg. Accordingly, it is desirable to select a curable epoxy resin composition and a curing agent that, when combined under ambient conditions, will form an epoxy reaction mixture that reaches an elevated temperature. For example, the epoxy reaction mixture preferably reaches a peak exotherm of at least about 80° F. (26.7° C.), or at least about 100° F. (37.8° C.) when formed under ambient conditions.

It is also desirable to select a curable epoxy resin composition and a curing agent that, when combined under ambient conditions, form an epoxy reaction mixture having a gel time sufficient to permit application to the outer surface of a pipe—as described in detail below-before the epoxy reaction mixture fully cures into a solid. For example, the epoxy reaction mixture preferably has a gel time (77° F. (25° C.)/150 g) of at least about 5 minutes (min), or at least about 10 min, or at least about 15 min, or at least about 20 min, or at least about 25 min, or at least about 30 min, or at least about 50 min, or at least about 80 min when cured under ambient conditions. In an embodiment, the epoxy reaction mixture has a gel time (77° F. (25° C.)/150 g) of from about 15 min to about 200 min, or from about 30 min to about 200 min, or from about 50 min to about 200 min, or from about 80 min to about 200 min, or from about 80 min to about 100 min. As used herein, the term “gel time” refers to the time period during which the epoxy reaction mixture is substantially free-flowing-stated equivalently, the time period beginning with the formation of the epoxy reaction mixture (when the curable epoxy composition is first contacted with the curing agent) and ending when the epoxy reaction mixture has cured (and therefore increased in viscosity) to the point where it can no longer be easily applied to a surface. During the gel time, the epoxy reaction mixture has a liquid or gel-like consistency and has a sufficiently low viscosity to be applied to the surface of a pipe and/or to penetrate the pores of a reinforcing material (e.g., woven carbon fiber) in accordance with the methods described herein. Following the gel time, the cured epoxy resin will be too viscous to apply to the surface of a pipe and/or to penetrate the pores of a reinforcing material as described in the methods provided herein.

In an embodiment, the epoxy reaction mixture has a pot life (77° F. (25° C.)/450 g) of at least about 15 min, or at least about 30 min, or at least about 45 min, or at least about 50 min. In another embodiment, the epoxy reaction mixture has a pot life (77° F. (25° C.)/450 g) of from about 15 min to about 200 min, or from about 30 min to about 200 min, or from about 50 min to about 200 min, or from about 50 min to about 100 min, or from about 50 min to about 75 min, or from about 50 min to about 60 min. “Pot life” is understood to mean the amount of time it takes for an initial mixed viscosity to double. Timing starts from the moment the curable epoxy resin composition and curing agent are combined and is measured at 77° F. (25° C.) on a 450-gram sample.

In an embodiment, the epoxy reaction mixture is void of peroxide, or is substantially void of, peroxide. For example, the epoxy reaction mixture is void of peroxides such as methyl ethyl ketone peroxide (“MEKP”) and cumyl hydroperoxide (“CUHP”).

In an embodiment, the epoxy reaction mixture is void of styrene, or is substantially void of, styrene.

In an embodiment, the epoxy reaction mixture is void of filler, or is substantially void of, filler. For example, the epoxy reaction mixture is void of filler such as clay, silica, and flake.

In an embodiment, the epoxy reaction mixture has one, some, or all of the following properties:
(a) a volume ratio of curable epoxy resin composition to curing agent of from about 1:1 to about 20:1, or from about 2:1 to about 15:1, or from about 2:1 to about 10:1, or from about 2:1 to about 4:1; and/or
(b) a gel time (77° F. (25° C.)/150 g) of from about 15 min to about 200 min, or from about 30 min to about 200 min, or from about 50 min to about 200 min, or from about 80 min to about 200 min, or from about 80 min to about 100 min; and/or
(c) a pot life (77° F. (25° C.)/450 g) of from about 15 min to about 200 min, or from about 30 min to about 200 min, or from about 50 min to about 200 min, or from about 50 min to about 100 min, or from about 50 min to about 75 min, or from about 50 min to about 60 min; and/or
(d) is void of peroxide, or is substantially void of peroxide (e.g., MEKP and CUHP); and/or
(e) is void of styrene, or is substantially void of styrene; and/or
(f) is void of filler, or is substantially void of filler (e.g., clay, silica, and flake).

### Reinforcing Material

The systems and methods disclosed herein utilize a reinforcing material that is capable of being applied to the outer surface 14 of a pipe 10. In some embodiments, the reinforcing material is a textile. As described in further detail below, the reinforcing material can form part of a cured composite material (along with the cured epoxy resin composition).

As used herein, “fabric” refers to a woven structure or a non-woven (such as knitted) structure formed from individual fibers or yarn.

As used herein, “fiber” and like terms refer to an elongated column of entangled filaments. Fiber diameter can be measured and reported in a variety of fashions. Generally, fiber diameter is measured in denier per filament. Denier is a textile term which is defined as the grams of the fiber per 9,000 meters of that fiber's length. Monofilament generally refers to an extruded strand having a denier per filament greater than 15, usually greater than 30. Fine denier fiber generally refers to fiber having a denier of 15 or less. Microdenier (aka microfiber) generally refers to fiber having a diameter not greater than 100 micrometers.

As used herein, “filament” and like terms refer to a single, continuous strand of elongated material having generally round cross-section and a length to diameter ratio of greater than 10.

As used herein, a “knitted fabric” is formed from intertwining yarn or fibers in a series of connected loops either by hand, with knitting needles, or on a machine. The fabric may be formed by warp or weft knitting, flat knitting, and circular knitting. Nonlimiting examples of suitable warp knits include tricot, raschel powernet, and lacing. Nonlimiting examples of suitable weft knits include circular, flat, and seamless (which is often considered a subset of circular knits).

As used herein, “nonwoven” refers to a web or a fabric having a structure of individual fibers or threads which are randomly interlaid, but not in an identifiable manner as is the case of a knitted fabric.

As used herein, “textile” refers to a flexible material composed of a network of natural fibers, artificial fibers, and combinations thereof. Textile includes fabric and cloth.

As used herein, “woven” refers to a web or a fabric having a structure of individual fibers or threads which are interlaid in a pattern in an identifiable manner. A nonlimiting example of a woven fabric is a knitted fabric.

As used herein, “yarn” is a continuous length of twisted or otherwise entangled filaments that can be used in the manufacture of woven or knitted fabrics.

Non-limiting examples of the reinforcing material include woven or knitted fabrics comprised of carbon fiber, aramid fiber, fiberglass, nylon, polyester, steel mesh, or basalt fiber. For example, the reinforcing material may comprise fiberglass. As a further example, the reinforcing material may comprise a para-aramid, for example, KEVLAR. A preferred reinforcing material is woven carbon fiber. In a particularly preferred embodiment, the reinforcing material is a carbon fiber mesh.

For example, the reinforcing material may comprise a carbon fiber mesh having a mesh weight of from about 100 g/m² to about 1500 g/m². More typically, the reinforcing material comprises a carbon fiber mesh having a mesh weight of from about 500 g/m² to about 750 g/m².

Conventional applications typically utilize heavy carbon fiber reinforcing material having a mesh weight of 1350 g/m² (i.e., 40 ounces per square yard) or greater. It has been discovered, however, that the use of such heavy fabrics provides a number of disadvantages, particularly for repairs on the interior surface of a pipe. For example, when heavy carbon fiber fabrics are saturated with resin and applied to the interior surface of a pipe, the combined weight of the fabric and resin can overcome the adhesion strength during the initial stages of the cure, resulting in the fabric falling loose from the interior surface of the pipe. Accordingly, in some embodiments, it is preferred that the reinforcing material comprises carbon fiber having a mesh weight of less than about 1350 g/m² (i.e., about 40 ounces per square yard), for example, less than about 1200 g/m² (i.e., about 35 ounces per square yard), less than about 1000 g/m² (i.e., about 30 ounces per square yard), less than about 850 g/m² (i.e., about 25 ounces per square yard), less than about 675 g/m² (i.e., about 20 ounces per square yard), less than about 500 g/m² (i.e., about 15 ounces per square yard), or even less than about 350 g/m² (i.e., about 10 ounces per square yard).

In some embodiments, a combination of reinforcing materials may be used to reinforce a pipe. For example, the methods described herein may utilize a first material as the first layer of reinforcing material, and a second material as a second layer of reinforcing material. The second material can be the same or different as the first material. For example, the first material can comprise fiberglass and the second layer can comprise carbon fiber. Additional layers are also contemplated being the same material or different material as the first or second material.

In an embodiment, a single type of reinforcing material is used to reinforce a pipe. In other words, one and only one type of reinforcing material is used to reinforce the pipe. For example, carbon fiber fabric may be the only reinforcing material used to reinforce the pipe.

In an embodiment, the reinforcing material is a continuous piece of fabric, such as a carbon fiber fabric, sized to encircle, or substantially encircle, the outer surface 14 of the pipe 10.

In an embodiment, the reinforcing material has one, some, or all of the following properties:
(a) is a carbon fiber mesh; and/or
(b) has a mesh weight of from about 100 g/m² to about 1500 g/m², or from about 500 g/m² to about 750 g/m²; and/or
(c) is a continuous piece of fabric sized to encircle, or substantially encircle, the outer surface 14 of the pipe 10.

### Cured Composite Material

The systems and methods disclosed herein utilize a cured composite material.

The cured composite material may be, for example, adhered to the outer surface 14 of the pipe 10. The cured composite material comprises a cured epoxy resin and a reinforcing material as described herein, and may further comprise one or more optional components as described herein. The cured composite material may be formed, for example, by contacting a reinforcing material with an epoxy reaction mixture as described in further detail below.

As used herein, the “cured” indicates that a composition has been substantially crosslinked. For example, the cured composite material may comprise a cured epoxy resin wherein a substantial portion (e.g., at least about 50%) of the vicinal epoxy groups have been crosslinked. In some embodiments, the cured composite material comprises a cured epoxy resin wherein at least about 60%, at least about 70%, at least about 80%, or at least about 90% of the vicinal epoxy groups have been crosslinked.

The cured composite material includes a cured epoxy resin composition having Tg of at least about 250° F. (121.1° C.). In an embodiment, the cured composite material comprises a cured epoxy resin composition having Tg of at least about 250° F. (121.1° C.), or at least about 260° F. (126.7° C.), at least about 270° F. (132.2° C.), or even higher. In an embodiment, the cured epoxy resin has a Tg of from about 250° F. (121.1° C.) to about 400° F. (204.4° C.), or from about 250° F. (121.1° C.) to less than about 400° F. (204.4° C.), or from about 250° F. (121.1° C.) to about 350° F. (176.7° C.), or from about 250° F. (121.1° C.) to about 300° F. (148.9° C.), or from about 260° F. (126.7° C.) to about 300° F. (148.9° C.), or from about 260° F. (126.7° C.) to about 280° F. (137.8° C.), or from about 260° F. (126.7° C.) to about 270° F. (132.2° C.).

In an embodiment, the cured composite material has a tensile strength of from about 60 kilo-pounds-per-inch (“kpsi”) (413.8 MPa), or about 65 kpsi (448.2 MPa), or about 70 kpsi (482.6 MPa), or about 71 kpsi (489.5 MPa) to about 125 kpsi (861.9 MPa), or about 150 kpsi (1034.2 MPa), or about 200 kpsi (1379.0 MPa), or about 300 kpsi (2068.4 MPa). In another embodiment, the cured composite material has a tensile strength of from about 60 kpsi (413.8 MPa) to about 300 kpsi (2068.4 MPa), or from about 60 kpsi (413.8 MPa) to about 200 kpsi (1379.0 MPa), or from about 60 kpsi (413.8 MPa) to about 100 kpsi (689.5 MPa), or from about 70 kpsi (482.6 MPa) to about 125 kpsi (861.9 MPa). Tensile strength is measured in accordance with ASTM D3039.

In an embodiment, the cured composite material has a tensile modulus of from about 4 kpsi (27.6 MPa), or about 5 kpsi (34.5 MPa) to about 14 kpsi (96.5 MPa), or about 15 kpsi (103.4 MPa), or about 20 kpsi (137.9 MPa), or about 30 kpsi (206.8 MPa), or about 50) kpsi (344.7 MPa), or about 100 kpsi (689.5 MPa), or about 200 kpsi (1379.0 MPa), or about 300 kpsi (2068.4 MPa), or about 500 kpsi (3447.4 MPa), or about 1,000 kpsi (6894.8 MPa). In another embodiment, the cured composite material has a tensile modulus of from about 4 kpsi (27.6 MPa) to about 1,000 kpsi (6894.8 MPa), or from about 4 kpsi (27.6 MPa) to about 100 kpsi (689.5 MPa), or from about 5 kpsi (34.5 MPa) to about 50 kpsi (344.7 Mpa), or from about 5 kpsi (34.5 MPa) to about 15 kpsi (103.4 MPa). Tensile modulus is measured in accordance with ASTM D3039.

In an embodiment, the cured composite material has a tensile strain at ultimate fail of from about 0.5%, or about 0.7% to about 1.4%, or about 1.5%, or about 2.0%. In another embodiment, the cured composite material has a tensile strain at ultimate fail of from about 0.5% to about 2.0%, or from about 0.5% to about 1.5%, or from about 0.7% to about 1.4%. Tensile strain at ultimate fail is measured in accordance with ASTM D3039.

In an embodiment, the cured composite material has a lap shear stress of from about 400 psi (2.76 MPa), or about 500 psi (3.45 MPa), or about 750 psi (5.17 MPa), or about 1,000 psi (6.89 MPa), or about 1,500 psi (10.3 MPa), or about 1,900 psi (13.1 MPa), or about 2,000 psi (13.8 MPa), or about 2,100 psi (14.5 MPa) to about 2,500 psi (17.2 MPa), or about 2,750 psi (19.0 MPa), or about 3,000 psi (20.7 MPa), or about 4,000 psi (27.6 MPa), or about 5,000 psi (34.5 MPa). In another embodiment, the cured composite material has a lap shear stress of from about 400 psi (2.76 MPa) to about 5,000 psi (34.5 MPa), or from about 500 psi (3.45 MPa) to about 3,000 psi (20.7 MPa), or from about 1,000 psi (6.89 MPa) to about 3,000 psi (20.7 MPa), or from about 1,500 psi (10.3 MPa) to about 3,000 psi (20.7 MPa), or from about 1,900 psi (13.1 MPa) to about 2,750 psi (19.0 MPa). Lap shear stress is measured in accordance with ASTM D3165.

In an embodiment, the cured composite material has a Poisson's Ratio of from about 0.15, or about 0.17, or about 0.35 to about 0.40, or about 0.94, or about 0.95, or about 0.97, or about 0.98. In another embodiment, the cured composite material has a Poisson's Ratio of from about 0.15 to about 0.98, or from about 0.15 to about 0.95, or from about 0.17 to about 0.94, or from about 0.35 to about 0.50. Poisson's Ratio is measured by the Chord Method in accordance with ASTM D3039.

In an embodiment, the cured composite material contains a cured epoxy resin has a Tg of from about 250° F. (121.1° C.) to about 400° F. (204.4° C.), or from about 250° F. (121.1° C.) to less than about 400° F. (204.4° C.), or from about 250° F. (121.1° C.) to about 350° F. (176.7° C.), or from about 250° F. (121.1° C.) to about 300° F. (148.9° C.), or from about 260° F. (126.7° C.) to about 300° F. (148.9° C.), or from about 260° F. (126.7° C.) to about 280° F. (137.8° C.), or from about 260° F. (126.7° C.) to about 270° F. (132.2° C.); and the cured composite material has one, some, or all of the following properties:
(a) a tensile strength of from about 60 kpsi (413.7 MPa) to about 300 kpsi (2068.4 MPa), or from about 60 kpsi (413.7 MPa) to about 200 kpsi (1379.0 MPa), or from about 60 kpsi (413.7 MPa) to about 100 kpsi (689.5 MPa), or from about 70 kpsi (482.6 MPa) to about 125 kpsi (861.8 MPa); and/or
(b) a tensile modulus of from about 4 kpsi (27.6 MPa) to about 1,000 kpsi (6894.8 MPa), or from about 4 kpsi (27.6 MPa) to about 100 kpsi (689.5 MPa), or from about 5 kpsi (34.5 MPa) to about 50 kpsi (344.7 MPa), or from about 5 kpsi (34.5 MPa) to about 15 kpsi (103.4 MPa); and/or
(c) a tensile strain at ultimate fail of from about 0.5% to about 2.0%, or from about 0.5% to about 1.5%, or from about 0.7% to about 1.4%; and/or
(d) a lap shear stress of from about 400 psi (2.76 MPa) to about 5,000 psi (34.5 MPa), or from about 500 psi (3.45 MPa) to about 3,000 psi (20.7 MPa), or from about 1,000 psi (6.89 MPa) to about 3,000 psi (20.7 MPa), or from about 1,500 psi (10.3 MPa) to about 3,000 psi (20.7 MPa), or from about 1,900 psi (13.1 MPa) to about 2,750 psi (19.0 MPa); and/or
(e) a Poisson's Ratio of from about 0.15 to about 0.98, or from about 0.15 to about 0.95, or from about 0.17 to about 0.94, or from about 0.35 to about 0.50.

### Method of Reinforcing a Pipe

Provided herein are methods for reinforcing a pipe having an outer surface.

More particularly, in preferred embodiments, the method comprises forming a cured composite material on the outer surface 14 of a pipe 10, wherein the cured composite material comprises a cured epoxy resin having Tg of at least about 250° F. (121.1° C.).

In general, in the methods provided herein, the epoxy reaction mixture and the reinforcing material are applied to the outer surface of the pipe, and the epoxy reaction mixture then cures in situ to form a composite reinforcing material adhered to the pipe outer surface. There are, generally, two methods by which the epoxy reaction mixture and the reinforcing material may be applied to the outer surface of a pipe: the wet lay-up method and the dry lay-up method. In the “wet lay-up” method, the reinforcing material is saturated with the liquid epoxy reaction mixture. The saturated reinforcing material is then applied directly to the outer surface of the pipe. One or more additional layers of saturated reinforcing material may be applied to create a reinforced pipe section having the desired thickness for a particular application.

In the “dry lay-up” method, at least a portion of the outer surface of the pipe is coated with the epoxy reaction mixture. A first layer reinforcing material is then applied over the portion of the outer pipe surface that has been “wetted” with the epoxy reaction mixture. Optionally, the reinforcing material may then be covered with a further layer of liquid epoxy reaction mixture.

Optionally, one or more additional layers of reinforcing material and epoxy reaction mixture may be applied to create a cured composite material having the desired thickness for a particular application. The cured composite material typically has a thickness of at least about 0.02 inches (0.51 mm), and more commonly at least about 0.03 inches (0.76 mm) (the typical thickness of a single layer). In an embodiment, each layer of cured composite material has a thickness of from about 0.02 in (0.51 mm), or about 0.03 in (0.76 mm) to about 0.04 in (1.0 mm), or about 0.05 in (1.3 mm), or about 0.07 in (1.8 mm), or about 0.08 in (2.0) mm), or about 0.09 in (2.3 mm), or about 0.10 in (2.5 mm), or about 0.15 in (3.8 mm), or about 0.20 in (5.1 mm). In another embodiment, each layer of cured composite material has a thickness of from about 0.02 in (0.51 mm) to about 0.20 in (5.1 mm), or from about 0.02 in (0.51 mm) to about 0.10 in (2.5 mm), or from about 0.03 in (0.76 mm) to about 0.80 in (20.3 mm). Typically, the cured composite material will comprise from 1 to about 30 layers, more typically from about 10 to about 20 layers. For example, the cured composite material may have a thickness of from about 0.02 in (0.51 mm), or about 0.03 in (0.76 mm) to about 0.04 in (1.0 mm), or about 0.05 in (1.3 mm), or about 0.07 in (1.8 mm), or about 0.08 in (2.0 mm), or about 0.09 in (2.3 mm), or about 0.10 in (2.5 mm), or about 0.15 in (3.8 mm), or about 0.20 in (5.1 mm), or about 0.50 in (12.7 mm), or about 0.75 in (19.1 mm), or about 1.0 in (25.4 mm), or about 2.0 in (50.8 mm), or about 3.0 in (76.2 mm), or about 4.0 in (101.6 mm), or about 5.0 in (127.0 mm). In an embodiment, the cured composite material has a thickness of from about 0.02 in (0.51 mm) to about 5.0 in (127.0 mm), or from about 0.02 in (0.51 mm) to about 1.0 in (25.4 mm), or from about 0.03 in (0.76 mm) to about 0.8 in (20.3 mm).

Under either the wet lay-up or dry lay-up the method, the epoxy reaction mixture is allowed to cure in situ, thereby forming a composite material attached to the outer surface of the pipe.

The epoxy reaction mixture and the reinforcing material are in direct contact with each other. The term “directly contacts,” as used herein, is a layer configuration whereby a layer of epoxy reaction mixture is located immediately adjacent to the reinforcing material, and no intervening layers, or no intervening structures, are present between the epoxy reaction mixture and the reinforcing material.

The epoxy reaction mixture is applied to the outer surface of the pipe and/or the reinforcing material. Nonlimiting examples of suitable procedures for applying the epoxy reaction mixture to the pipe and/or the reinforcing material include dipping, immersing, brushing, spraying (airless or conventional spray), phenolic core roller, or pouring. Other methods of application known in the prior art are also within the scope of the present disclosure.

In an embodiment, the epoxy reaction mixture is uniformly applied on the outer surface of the pipe or on a surface of the reinforcing material to form a layer. A “uniform application” is a layer of the epoxy reaction mixture that is continuous (not intermittent) across a surface of the pipe or reinforcing material, and of the same, or substantially the same, thickness across the outer surface of the pipe or reinforcing material. In other words, an epoxy reaction mixture that is uniformly applied to a pipe or reinforcing material directly contacts the pipe or reinforcing material. The epoxy reaction mixture may or may not be coextensive with the pipe or reinforcing material surface.

In one embodiment, the epoxy reaction mixture saturates the reinforcing material. In other words, the epoxy reaction mixture homogenously penetrates, or substantially homogenously penetrates, into the reinforcing material, such that all, or substantially all, of the fibers of the reinforcing material are contacted with the epoxy reaction mixture.

In one embodiment, the composite material is formed by in situ curing the epoxy reaction mixture. In a further embodiment, the in situ curing conditions include exposing the epoxy reaction mixture to ambient conditions (i.e., from 45° F. (7.2° C.) to 100° F. (37.8° C.), at a dew point that is within 5° F. (2.8° C.) of the air temperature, and from 20% to 95% relative humidity) for a period of from 5 min, or 30 min, or 1 hour, or 6 hours, or 12 hours, or 24 hours to 48 hours, or 72 hours, or 96 hours, or 168 hours. In a preferred embodiment, composite material is formed by in situ curing the epoxy reaction mixture without the application of heat from an external source.

In an embodiment, the reinforcing material does not directly contact the outer surface 14 of the pipe 10. In other words, there is an intervening layer between the reinforcing material and the outer surface 14 of the pipe, such as a layer of cured epoxy resin or an insulating layer. A nonlimiting example of a suitable insulating layer is a veil fiberglass.

In an embodiment, an insulating layer (e.g., veil fiberglass) encircles, or substantially encircles, the outer surface 14 of the pipe 10. The insulating layer directly contacts the outer surface 14 of the pipe 10. A first layer of the epoxy reaction mixture is applied to an outer surface of the insulating layer such that the first layer directly contacts the insulating layer. The reinforcing material is applied over at least a portion of the first layer, such that the reinforcing material directly contact the first layer (but does not directly contact the outer surface 14 of the pipe 10). A second layer of the epoxy reaction is applied over at least a portion of the reinforcing material, such that the second layer directly contact the reinforcing material. The epoxy reaction mixture is cured in situ to form a cured composite material attached to the outer surface 14 of the pipe 10.

In an embodiment, the method of reinforcing a pipe 10 having an outer surface 14 includes:
(a) combining the curable epoxy resin composition (e.g., containing an epoxy phenolic resin) and the curing agent (e.g., containing a diamine), thereby forming an epoxy reaction mixture;
(b) optionally, cleaning the outer surface 14 of the pipe 10;
(c) optionally, treating the outer surface 14 of the pipe 10 via mechanical grinding;
(d) within 24 hours of the cleaning and/or treating steps, applying a first layer of the epoxy reaction mixture to the outer surface 14 of the pipe 10;
(e) applying a reinforcing material (e.g., a carbon fiber fabric) over at least a portion of the first layer;
(f) applying a second layer of the epoxy reaction mixture over at least a portion of the reinforcing material; and
(g) allowing the epoxy reaction mixture to cure in situ, thereby forming a cured composite material attached to the outer surface of the pipe;
wherein the composite material comprises a cured epoxy resin composition having a Tg of from about 250° F. (121.1° C.) to about 400° F. (204.4° C.), or from about 250° F. (121.1° C.) to less than about 400° F. (204.4° C.), or from about 250° F. to about 350° F. (176.7° C.), or from about 250° F. (121.1° C.) to about 300° F. (148.9° C.), or from about 260° F. (126.7° C.) to about 300° F. (148.9° C.), or from about 260° F. (126.7° C.) to about 280° F. (137.8° C.), or from about 260° F. (126.7° C.) to about 270° F. (132.2° C.).

In an embodiment, the method of reinforcing a pipe 10 having an outer surface 14 includes:
(a) combining the curable epoxy resin composition (e.g., containing an epoxy phenolic resin) and the curing agent (e.g., containing a diamine), thereby forming an epoxy reaction mixture;
(b) optionally, cleaning the outer surface 14 of the pipe 10;
(c) optionally, treating the outer surface 14 of the pipe 10 via mechanical grinding;
(d) within 24 hours of the cleaning and/or treating steps, applying the epoxy reaction mixture over at least a portion of a reinforcing material (e.g., a carbon fiber fabric) in a sufficient amount that the reinforcing material becomes saturated with the epoxy reaction mixture;
(e) applying the saturated reinforcing material to at least a portion of the outer surface of the pipe;
(f) allowing the epoxy reaction mixture to cure in situ, thereby forming a cured composite material attached to the outer surface of the pipe;
wherein the composite material comprises a cured epoxy resin composition having a Tg of from about 250° F. (121.1° C.) to about 400° F. (204.4° C.), or from about 250° F. (121.1° C.) to less than about 400° F. (204.4° C.), or from about 250° F. (121.1° C.) to about 350° F. (176.7° C.), or from about 250° F. (121.1° C.) to about 300° F. (148.9° C.), or from about 260° F. (126.7° C.) to about 300° F. (148.9° C.), or from about 260° F. (126.7° C.) to about 280° F. (137.8° C.), or from about 260° F. (126.7° C.) to about 270° F. (132.2° C.).

In an embodiment, a system for reinforcing the outer surface 14 of a pipe 10 is provided. The system includes:
(a) a curable epoxy resin composition containing an epoxy phenolic resin (e.g., bisphenol A diglycidyl ether resin);
(b) a curing agent comprising a diamine (e.g., isophorone diamine and/or 2,2,4-trimethyl-1,6-hexanediamine); and
(c) a carbon fiber material configured for application to the outer surface 14 of a pipe 10; wherein the curable epoxy resin composition and the curing agent are present in a ratio that, when combined, will form a cured epoxy resin composition having a Tg of at least about 250° F. (121.1° C.), or from about 250° F. (121.1° C.) to about 400° F. (204.4° C.), or from about 250° F. (121.1° C.) to less than about 400° F. (204.4° C.), or from about 250° F. (121.1° C.) to about 350° F. (176.7° C.), or from about 250° F. (121.1° C.) to about 300° F. (148.9° C.), or from about 260° F. (126.7° C.) to about 300° F. (148.9° C.), or from about 260° F. (126.7° C.) to about 280° F. (137.8° C.), or from about 260° F. (126.7° C.) to about 270° F. (132.2° C.).

### Reinforced Pipe

Also provided is a reinforced pipe that is prepared using a method as described above. The reinforced pipe may, for example, comprise a composite material adhered to the outer surface of the pipe, wherein the composite material is prepared and applied to the outer surface of the pipe as generally described above. The composite material includes a cured epoxy resin composition having a Tg of at least about 250° F. (121.1° C.).

In an embodiment, the composite material includes a cured epoxy resin composition having a Tg of from about 250° F. (121.1° C.) to about 400° F. (204.4° C.), or from about 250° F. (121.1° C.) to less than about 400° F. (204.4° C.), or from about 250° F. (121.1° C.) to about 350° F. (176.7° C.), or from about 250° F. (121.1° C.) to about 300° F. (148.9° C.), or from about 260° F. (126.7° C.) to about 300° F. (148.9° C.), or from about 260° F. (126.7° C.) to about 280° F. (137.8° C.), or from about 260° F. (126.7° C.) to about 270° F. (132.2° C.).

Other objects and features will be in part apparent and in part pointed out hereinafter.

### Examples

The following non-limiting examples are provided to further illustrate the present disclosure.

### Differential Scanning Calorimetry (DSC)

Differential Scanning calorimetry (DSC) can be used to measure the melting and glass transition behavior of a composition over a wide range of temperature. For these examples, a Perkin Elmer DSC-7 Differential Scanning calorimeter is used for this analysis. Indium calibration scans are run immediately before, and immediately after the plaque sample was run. Calibration scans are run from 15° C. to 210° C. at 20° C. per minute.

The thermal behavior of the sample is determined by ramping the sample temperature up and down to create a heat flow versus temperature profile. In other words, the plaque analysis is run as heating and cooling curves. The heating curve is run from 15° C. to 225° C. at 5° C. per minute. The cooling curve is run from 225° C. to 15° C. at 10° C. per minute. The cooling and second heating curves are recorded. The cool curve is analyzed by setting baseline endpoints from the beginning of crystallization to −20° C. The heat curve is analyzed by setting baseline endpoints from −20° C. to the end of melt. The values determined are extrapolated onset of melting, Tm, and extrapolated onset of crystallization, Tc.

Melting point, Tm, is determined from the DSC heating curve by first drawing the baseline between the start and end of the melting transition. A tangent line is then drawn to the data on the low temperature side of the melting peak. Where this line intersects the baseline is the extrapolated onset of melting (Tm). This is as described in Bernhard Wunderlich, The Basis of Thermal Analysis, in Thermal Characterization of Polymeric Materials 92, 277-278 (Edith A. Turi ed., 2d ed. 1997).

Glass transition temperature, Tg, is determined from the DSC heating curve where half the sample has gained the liquid heat capacity as described in Bernhard Wunderlich, The Basis of Thermal Analysis, in Thermal Characterization of Polymeric Materials 92, 278-279 (Edith A. Turi ed., 2d ed. 1997). Baselines are drawn from below and above the glass transition region and extrapolated through the Tg region. The temperature at which the sample heat capacity is half-way between these baselines is the Tg.

### Materials

The components described below were used in each of the following examples, unless otherwise indicated.

TABLE 1
Materials

| Name | Description | Properties | Supplier |
|---|---|---|---|
| NSP 120 | 2-component epoxy coating that | See Table 2 | NSP |
| | contains (A) a modified epoxy | | Specialty |
| | resin, (B) a proprietary blend | | Products |
| | amine curing agent, and (C) filler | | |
| | (clay, silica, flake, etc.). | | |
| Curable Epoxy | 80-90 wt % bisphenol A | Flash Point = 78° C. | Next |
| Resin | diglycidyl ether resin and 5-10 | Density = 1.13 g/cc | Composite |
| Composition A | wt % butyl glycidyl ether, based | | Solutions |
| | on the total weight of the | | |
| | composition | | |
| Curing Agent | 40-50 wt % benzyl alcohol; 40- | Flash Point = | Next |
| Composition B | 50 wt % isophorone diamine; 5- | 106° C. | Composite |
| | 10 wt % bisphenol A diglycidyl | Density = 1.01 g/cc | Solutions |
| | ether resin; 1-5 wt % 2,2,4- | | |
| | trimethyl-1,6-hexanediamine; | | |
| | and 1-5 wt % phenol, based on | | |
| | the total weight of the | | |
| | composition | | |
| Panex 35 | Reinforcing material | Weight = 600 | Zoltek |
| | unidirectional carbon fiber mesh | gm/m3 | |
| | with two opposing surfaces | | |

### Comparative Sample 1 Cured Epoxy Resin

Comparative Sample 1 is prepared using NSP 120. The (A) a modified epoxy resin and (B) a proprietary blend amine curing agent are combined at 60-75° F. (15.6-23.9° C.) at a volume ratio of A:B of 2:1. The (B) amine curing agent is poured into the (A) modified epoxy resin and mixed for 3 minutes under ambient conditions using a mechanical drill equipped with a Jiffy mixer head. To ensure complete mixing, the sides and bottom of the container are scraped, and the Comparative Sample 1 Epoxy Reaction Mixture is mixed for an additional 1-2 minutes. The Comparative Sample 1 Epoxy Reaction Mixture is then allowed to fully cure under ambient conditions to form Comparative Sample 1 Cured Epoxy Resin. The properties of the Comparative Sample 1 Cured Epoxy Resin are provided below in Table 2.

As shown in Table 2, Comparative Sample 1 Cured Epoxy Resin has a Tg of less than 250° F. (121.1° C.), specifically, 204° F. (95.6° C.). Consequently, Comparative Sample 1 Cured Epoxy Resin is expected to fail at when exposed to a temperature of 212° F. (100° C.) or greater. In other words, Comparative Sample 1 Cured Epoxy Resin is not suitable for reinforcing a high-temperature, high pressure pipe that reaches a temperature of 212° F. (100° C.) or more during use (e.g., commercial piping systems for municipal, fossil power, nuclear power, and heavy industry).

Not wishing to be bound by any particular theory, it is believed that the presence of filler in Comparative Sample 1 Cured Epoxy Resin results in a Tg that is lower than the same composition that is void of filler.

TABLE 2
Comparative Sample 1 Cured Epoxy Resin Properties

| Property | Test Method | Value | |
|---|---|---|---|
| Pot Life | 77° F./25° C. | 30 min | |
| Tensile Strength | ASTM D638 | 5600 psi | (38.6 MPa) |
| Compressive Strength | ASTM D695 | 11700 psi | (80.1 MPa) |
| Flexural Strength | ASTM D790 | 8900 psi | (61.4 MPa) |
| Tensile Elongation | ASTM D638 | 5% | |
| Shore D Hardness | ASTM 2240 | 90 | |
| Tg | DSC | 204° F. | (95.6° C.) |

### Sample 2 Cured Epoxy Resin

Sample 2 is prepared using Curable Epoxy Resin Composition A and Curing Agent Composition B. Prior to mixing, the Curable Epoxy Resin Composition A and Curing Agent Composition B each is held at a temperature of 60-85° F. (15.6-29.4° C.). The Curable Epoxy Resin Composition A and Curing Agent Composition B are combined at an A:B volume ratio of 2:1. The Curing Agent Composition B is poured into the Curable Epoxy Resin Composition A and mixed for 3 minutes under ambient conditions using a mechanical drill equipped with a Jiffy mixer head. To ensure complete mixing, the sides and bottom of the container are scraped, and the Sample 2 Epoxy Reaction Mixture is mixed for an additional 1-2 minutes. The Sample 2 Epoxy Reaction Mixture is void of filler, styrene, and peroxide.

The Sample 2 Epoxy Reaction Mixture is then allowed to fully cure under ambient conditions to form Sample 2 Cured Epoxy Resin. The properties of the Sample 2 Cured Epoxy Resin are provided below in Table 3.

TABLE 3
Cured Epoxy Resin Properties

| | | Sample 2 Cured Epoxy |
|---|---|---|
| Property | Test Method | Resin Properties |
| Pot Life | 77° F./25° C. | 58 min |
| Gel Time | 77° F./25° C. | 87 min |
| Tg | DSC | 264° F. (128.9° C.) |

### Sample 3 Reinforced Pipe

A high-pressure, high-temperature pipe is provided, such as the pipe 10 of FIG. 1. The high-pressure, high-temperature pipe is a hot water pipe that is suitable for transporting components at (i) a pressure of 50 PSI (344.7 kPa) and (ii) a temperature of 155-170° F. (68.3-76.7° C.). The high-pressure, high-temperature pipe has a pipe run of 1,100 ft (335.3 m), an internal diameter of 6 inches (15.24 cm), a wall thickness of 0.375 inches (9.53 mm), and an outer diameter of 6.750 inches (17.15 cm). The high-pressure, high-temperature pipe is a carbon steel pipe. The pipe is supported by supports positioned about every 4 feet (1.2 m) along the length of the pipe. The high-pressure, high-temperature pipe is located in the ground during operation, under about 4 feet (1.2 m) of soil. The high-pressure, high-temperature pipe is corroded and requires reinforcement that will provide the strength to resist the expected loads (50 PSI (344.7 kPa), in addition to the pressure exerted on the pipe by the soil) at the operating temperature (155-170° F. (68.3-76.7° C.)). The soil around the corroded area of the high-pressure, high-temperature pipe is removed.

Prior to reinforcing, the hot water system is shut down, such that no water is flowing through the high-pressure, high-temperature pipe. The outer surface of the pipe is cleaned to remove all surface paint, mill scale, oil, rust, and other contaminants. Then, the outer surface of the pipe is treated with mechanical grinding to achieve a slightly roughened texture. The ground steel surface is cleaned by solvent wiping and allowed to dry. The Sample 2 Epoxy Reaction Mixture is applied to the dried outer surface of the pipe, as described below, within 24 hours of solvent wiping.

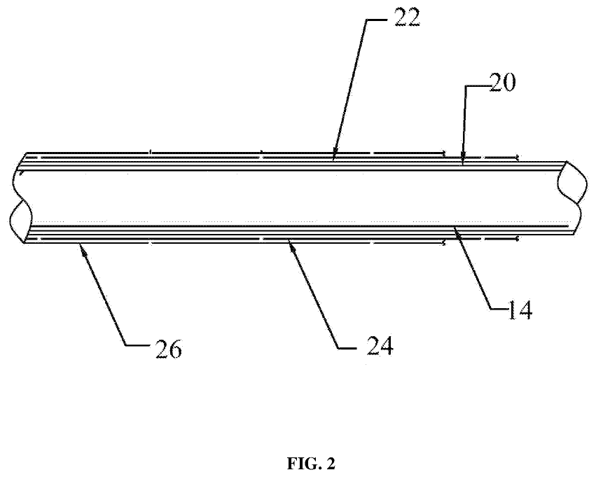

An galvanic insulation layer 26 of veil fiberglass is placed around the circumference of the pipe, as shown in FIG. 2. The veil fiberglass directly contacts the outer surface 14 of the pipe.

The Sample 2 Epoxy Reaction Mixture is prepared as discussed above. The Sample 2 Epoxy Reaction Mixture is applied over three pieces of PANEX 35 carbon fiber, in a sufficient amount that the reinforcing material becomes saturated with the Sample 2 Epoxy Reaction Mixture. The first piece of saturated reinforcing material is applied around the circumference of the pipe, onto the veil fiberglass, with the fibers of the reinforcing material extending in a longitudinal direction (i.e., along the length of the pipe) to form a first layer 22. The second piece of saturated reinforcing material is applied around the circumference of the pipe, onto the first layer, with the fibers of the reinforcing material extending circumferentially around the exterior of the pipe (i.e., perpendicular to the fibers in the first layer) to form a second layer 24. The third piece of saturated reinforcing material is applied around the circumference of the pipe, onto the second layer, with the fibers of the reinforcing material extending circumferentially around the exterior of the pipe (i.e., parallel to the fibers in the second layer) to form a third layer 26. Then, the Sample 2 Epoxy Reaction Mixture is cured in situ, thereby forming a Sample 3 Cured Composite Material attached to the outer surface 14 of the pipe.

The first layer 22 has a thickness of 0.037 inches (0.94 mm). The second layer 24 has a thickness of 0.074 inches (1.88 mm). The third layer has a thickness of 0.074 inches (1.88 mm).

After curing the hot water system is re-started. No leaks are visually detected. The pipe is then re-covered with soil.

It was unexpectedly found that the Sample 3 Reinforced Pipe that is reinforced with Sample 3 Cured Composite, which contains Sample 3 Cured Epoxy Resin having a Tg of at least 250° F. (121.1° C.), specifically, 264° F. (128.9° C.), is able to withstand the expected loads (50 PSI (344.7 kPa), in addition to the pressure exerted on the pipe by the soil) at the operating temperature (155-170° F., or 68.3-76.7° C.).

### Cured Composite Material Properties

The Panex 35 carbon fiber is cut into pieces sized for property testing according to the relevant ASTM. The Sample 2 Epoxy Reaction Mixture is prepared as discussed above. The Sample 2 Epoxy Reaction Mixture is applied over the pieces of Panex 35 carbon fiber, in a sufficient amount that the reinforcing material becomes saturated with the Sample 2 Epoxy Reaction Mixture.

The saturated reinforcing material is cured in situ, thereby forming Cured Composite Material. The properties of the Cured Composite Material are provided below in Tables 4, 5 and 6.

TABLE 4
Cured Composite Material Lap Shear Properties (ASTM D3165)

| | | | | | Lap Shear |
|---|---|---|---|---|---|
| Specimen | Width | Overlap | Area | Load | Stress |
| ID | (in (mm)) | (in (mm)) | (in² (cm²)) | (lbs. (kg)) | (psi (MPa)) |
| 1 | 0.960 (24.4) | 1.468 (37.3) | 1.409 (9.471) | 2,752 (1,248) | 1,953 (13.466) |
| 2 | 0.982 (24.9) | 1.279 (32.5) | 1.256 (8.103) | 3,141 (1,425) | 2,501 (17.244) |
| 3 | 0.975 (24.8) | 1.389 (35.3) | 1.354 (8.735) | 2,984 (1,354) | 2,204 (15.196) |
| 4 | 0.980 (24.9) | 1.337 (34.0) | 1.310 (8.452) | 2,649 (1,202) | 2,022 (13.941) |
| 5 | 0.967 (24.6) | 1.459 (37.1) | 1.411 (9.103) | 2,789 (1,265) | 1,977 (13.631) |
| Average | | | | | 2,131 (14.693) |

TABLE 5
Cured Composite Material Tensile Properties (ASTM D3039)

| | | | | | Tensile | Tensile | Strain |
|---|---|---|---|---|---|---|---|
| | Width | Thickness | Area | Load | Strength | Modulus | % at |
| Specimen | (in | (in | (in² | (lbs. | (psi | (×10⁶ psi | Ultimate |
| ID | (mm)) | (mm) | (mm²)) | (kg)) | (MPa)) | (GPa)) | Fail |
| 6 | 0.469 | 0.100 | 0.0469 | 3,621 | 77,210 | 5.09 | 1.30 |
| | (11.9) | (2.54) | (30.26) | (1,642) | (532.34) | (35.09) | |
| 7 | 0.466 | 0.101 | 0.0471 | 4,102 | 87,150 | 6.48 | 1.10 |
| | (11.8) | (2.57) | (30.39) | (1,860) | (600.88) | (44.68) | |
| 8 | 0.465 | 0.089 | 0.0414 | 3,689 | 89,140 | 9.67 | 0.90 |
| | (11.8) | (2.26) | (26.71) | (1,673) | (614.60) | (66.67) | |
| 9 | 0.460 | 0.077 | 0.0354 | 4,281 | 120,860 | 10.60 | 1.30 |
| | (11.7) | (1.96) | (22.84) | (1,942) | (833.30) | (73.08) | |
| 10 | 0.465 | 0.102 | 0.0474 | 3,979 | 83,890 | 5.80 | 0.90 |
| | (11.8) | (2.59) | (30.58) | (1,805) | (578.40) | (39.99) | |
| 11 | 0.456 | 0.077 | 0.0351 | 4,247 | 120,960 | 11.40 | 1.40 |
| | (11.6) | (1.96) | (22.65) | (1,926) | (833.99) | (78.60) | |
| 12 | 0.460 | 0.074 | 0.0340 | 3,791 | 111,370 | 9.56 | 1.10 |
| | (11.7) | (1.88) | (21.94) | (1,720) | (767.87) | (65.91) | |
| 13 | 0.462 | 0.088 | 0.0407 | 3,945 | 94,570 | 5.65 | 1.40 |
| | (11.7) | (2.24) | (26.26) | (1,789) | (652.04) | (38.96) | |
| 14 | 0.454 | 0.083 | 0.0377 | 3,864 | 102,540 | 8.36 | 1.40 |
| | (11.5) | (2.11) | (24.32) | (1,753) | (706.99) | (57.64) | |
| 15 | 0.461 | 0.095 | 0.0438 | 4,008 | 91,520 | 7.42 | 1.30 |
| | (11.7) | (2.41) | (28.26) | (1,818) | (631.01) | (51.16) | |
| 16 | 0.460 | 0.079 | 0.0363 | 4,058 | 111,670 | 13.1 | 0.90 |
| | (11.7) | (2.01) | (23.42) | (1,841) | (769.94) | (90.32) | |
| 17 | 0.462 | 0.100 | 0.0462 | 3,502 | 75,800 | 7.69 | 1.00 |
| | (11.7) | (2.54) | (29.81) | (1,588) | (522.62) | (53.02) | |
| 18 | 0.470 | 0.108 | 0.0508 | 3,644 | 71,790 | 8.37 | 1.00 |
| | (11.9) | (2.74) | (32.77) | (1,653) | (494.97) | (57.71) | |
| 19 | 0.444 | 0.086 | 0.0382 | 4,057 | 106,250 | 10.5 | 1.00 |
| | (11.3) | (2.18) | (24.65) | (1,840) | (732.57) | (72.39) | |
| 20 | 0.453 | 0.106 | 0.0480 | 3,588 | 74,720 | 7.81 | 1.00 |
| | (11.5) | (2.69) | (30.97) | (1,627) | (515.18) | (53.85) | |
| 21 | 0.459 | 0.083 | 0.0381 | 4,128 | 108,350 | 10.5 | 1.10 |
| | (11.7) | (2.11) | (24.58) | (1,872) | (747.05) | (72.39) | |
| 22 | 0.470 | 0.093 | 0.0437 | 3,540 | 80,990 | 9.73 | 0.80 |
| | (11.9) | (2.36) | (28.19) | (1,606) | (558.41) | (67.09) | |
| 23 | 0.465 | 0.106 | 0.0493 | 3,579 | 72,610 | 9.13 | 0.90 |
| | (11.8) | (2.69) | (31.81) | (1,623) | (500.63) | (62.95) | |
| 24 | 0.462 | 0.084 | 0.0388 | 3,033 | 78,150 | 12.2 | 0.70 |
| | (11.7) | (2.14) | (25.03) | (1,376) | (538.83) | (84.12) | |
| 25 | 0.464 | 0.109 | 0.0506 | 3,901 | 77,130 | 11.5 | 0.90 |
| | (11.8) | (2.77) | (32.65) | (1,769) | (531.79) | (79.29) | |
| Average | 0.460 | 0.092 | | | 91,834 | 9.03 | 1.07 |
| | (11.7) | (2.34) | | | (633.17) | (62.26) | |
| Std Dev | 0.006 | 0.011 | | | 16,571 | 2.26 | 0.21 |
| | (0.152) | (0.279) | | | (114.25) | (15.58) | |
| Minimum | 0.440 | 0.074 | | | 71,790 | 5.09 | 0.70 |
| | (11.2) | (1.88) | | | (494.97) | (35.09) | |

TABLE 6
Cured Composite Material Poisson's Ratio
Properties (ASTM D3039 Chord Method)

| | Transverse Strain | Transverse Strain | | |
|---|---|---|---|---|
| Specimen | @ 1000 με | @ 3000 με | Differ- | Poisson's |
| ID | Longitudinal | Longitudinal | ence | Ratio |
| 26 | −280 | −980 | −700 | 0.35 |
| 27 | −523 | −1200 | −677 | 0.34 |
| 28 | −423 | −956 | −533 | 0.27 |
| 29 | −44 | −990 | −946 | 0.47 |
| 30 | −509 | −1099 | −590 | 0.30 |
| 31 | −440 | −1338 | −898 | 0.45 |
| 32 | −340 | −868 | −528 | 0.26 |
| 33 | −222 | −830 | −608 | 0.30 |
| 34 | −354 | −1030 | −676 | 0.34 |
| 35 | −228 | −730 | −502 | 0.25 |
| 36 | −630 | −1950 | −1320 | 0.66 |
| Average | | | | 0.36 ± 0.07 |

An exemplary ASTM D3165 Lap Shear Specimen was used to measure the values presented in Table 4. An exemplary ASTM D3039 Tensile Specimen was used to measure the values of Table 5.

### Exemplary Dry Layup Method

An exemplary method for “dry layup” repair of a pipe surface may be performed as follows:
1) After prescribed surface preparation of substrate, apply the curable epoxy resin composition at nominal 7 mils thickness via brush and/or roller method to substrate.
2) While resin is still in wet state, embed fiberglass veil (if required for galvanic insulation) into resin using hand pressure followed by roller pressure to remove any bubbles or wrinkles. Fiberglass layer should cover entirety of substrate but does not need specific overlaps or orientation.
3) After fiberglass is smooth, apply the curable epoxy resin composition at nominal 7 mils thickness via brush and/or roller method to fiberglass.
4) After minimum 30 minute dwell time, apply the curable epoxy resin composition at nominal 18 mils thickness via brush and/or roller method over fiberglass.
5) While resin is still in wet state, embed one layer of uni-directional or bi-directional carbon fiber fabric into resin using hand pressure followed by roller pressure to remove bubbles or wrinkles. Orientation of fabric and overlaps to be determined by project specific engineering drawings.
6) After carbon fiber fabric is smooth, apply the curable epoxy resin composition at nominal 16 mils thickness to carbon fiber fabric.
7) Repeat steps 4-6 until layering per design documents is complete.

### Exemplary Wet Layup Method

An exemplary method for “wet layup” repair of a pipe surface may be performed as follows:
1) After prescribed surface preparation of substrate, apply the curable epoxy resin composition at nominal 7 mils thickness via brush and/or roller method to substrate.
2) While resin is still in wet state, embed fiberglass veil (if required for galvanic insulation) into resin using hand pressure followed by roller pressure to remove any bubbles or wrinkles. Fiberglass layer should cover entirety of substrate but does not need specific overlaps or orientation.
3) Using commercially available saturating equipment (see below for example), saturate pre-cut lengths of NCS3118 or NCS3218 (uni-directional and bi-directional carbon fiber fabric respectively) onto take up roll.
4) Unroll saturated carbon fiber onto fiberglass and press into place using hand pressure followed by roller pressure to remove any bubbles or wrinkles. Orientation of fabric and overlaps to be determined by project specific engineering drawings.
5) Repeat steps 3-4 until layering per design documents is complete.

When introducing elements of the present disclosure or the preferred embodiment(s) thereof, the articles “a”, “an”, “the”, and “said” are intended to mean that there are one or more of the elements. The terms “comprising”, “including”, and “having” are intended to be inclusive and mean that there may be additional elements other than the listed elements. In contrast, the term “consisting essentially of” excludes from the scope of any succeeding recitation any other component, step, or procedure, excepting those that are not essential to operability. The term “consisting of” excludes any component, step, or procedure not specifically delineated or listed. The term “or,” unless stated otherwise, refers to the listed members individually as well as in any combination. Use of the singular includes use of the plural and vice versa.

The numerical ranges disclosed herein include all values from, and including, the lower and upper value. For ranges containing explicit values (e.g., a range from 1, or 2, or 3 to 5, or 6, or 7), any subrange between any two explicit values is included (e.g., the range 1-7 above includes subranges 1 to 2:2 to 6:5 to 7:3 to 7:5 to 6; etc.).

Unless stated to the contrary, implicit from the context, or customary in the art, all parts and percentages are based on weight and all test methods are current as of the filing date of this disclosure.

The term “composition” refers to a mixture of materials which comprise the composition, as well as reaction products and decomposition products formed from the materials of the composition.

The total weight percentage of each composition, component, and blend disclosed herein is 100 wt %.

In view of the above, it will be seen that several objects of the disclosure are achieved, and other advantageous results attained.

As various changes could be made in the above products and methods without departing from the scope of the disclosure, it is intended that all matter contained in the above description shall be interpreted as illustrative and not in a limiting sense.

What is claimed is:

1. A method of reinforcing a pipe having an inner surface, the method comprising:
combining a curable epoxy resin composition and a curing agent, thereby forming an epoxy reaction mixture;
applying a first layer of epoxy reaction mixture to the inner surface of the pipe;
applying a reinforcing material over at least a portion of the first layer;
applying a second layer of the epoxy reaction mixture over at least a portion of the reinforcing material;
and allowing the epoxy reaction mixture to cure in situ, thereby forming a cured composite material attached to the inner surface of the pipe;
wherein the composite material comprises a cured epoxy resin composition having a Tg of at least about 250° F. (121.1° C.).

2. A method of reinforcing a pipe having an inner surface, the method comprising:
combining a curable epoxy resin composition and a curing agent, thereby forming an epoxy reaction mixture;
applying the epoxy reaction mixture over at least a portion of a reinforcing material in a sufficient amount that the reinforcing material becomes saturated with the epoxy reaction mixture;
applying the saturated reinforcing material to at least a portion of the inner surface of the pipe;
and allowing the epoxy reaction mixture to cure in situ, thereby forming a cured composite material attached to the inner surface of the pipe;
wherein the composite material comprises a cured epoxy resin composition having a Tg of at least about 250° F. (121.1° C.).

3. A method of reinforcing a pipe having an outer surface, the method comprising:
combining a curable epoxy resin composition and a curing agent, thereby forming an epoxy reaction mixture;
applying a first layer of epoxy reaction mixture to the outer surface of the pipe;
applying a reinforcing material over at least a portion of the first layer;
applying a second layer of the epoxy reaction mixture over at least a portion of the reinforcing material;
and allowing the epoxy reaction mixture to cure in situ, thereby forming a cured composite material attached to the outer surface of the pipe;
wherein the composite material comprises a cured epoxy resin composition having a Tg of at least about 250° F. (121.1° C.).

4. A method of reinforcing a pipe having an outer surface, the method comprising:
combining a curable epoxy resin composition and a curing agent, thereby forming an epoxy reaction mixture;
applying the epoxy reaction mixture over at least a portion of a reinforcing material in a sufficient amount that the reinforcing material becomes saturated with the epoxy reaction mixture;
applying the saturated reinforcing material to at least a portion of the outer surface of the pipe;
and allowing the epoxy reaction mixture to cure in situ, thereby forming a cured composite material attached to the outer surface of the pipe;
wherein the composite material comprises a cured epoxy resin composition having a Tg of at least about 250° F. (121.1° C.).

5. The method of claim 1 wherein the epoxy reaction mixture is permitted to cure under ambient conditions.

6. The method of claim 1 wherein the reinforcing material comprises a material selected from the group consisting of carbon fiber, aramid fiber, fiberglass, nylon, polyester, steel mesh, or a combination thereof.

7. The method of claim 6 wherein the reinforcing material comprises carbon fiber.

8. The method of claim 7 wherein the reinforcing material comprises woven carbon fiber.

9. The method of claim 7 wherein the reinforcing material comprises carbon fiber having a mesh weight of less than about 1350 g/m².

10. The method of claim 1 wherein the curable epoxy resin composition comprises at least one epoxy resin selected from the group consisting of epoxy phenolic resin, novolac epoxy resins, and combinations thereof.

11. The method of claim 10 wherein the curable epoxy resin composition comprises an epoxy phenolic resin.

12. The method of claim 11 wherein the curable epoxy resin composition comprises a bisphenol A diglycidyl ether resin.

13. The method of claim 1 wherein the curing agent comprises a diamine.

14. The method of claim 13 wherein the curing agent is selected from the group consisting of isophorone diamine, 2,2,4-trimethyl-1,6-hexanediamine, phenol, benzyl alcohol, and combinations thereof.

15. The method of claim 14 wherein the curing agent comprises isophorone diamine and 2,2,4-trimethyl-1,6-hexanediamine.

16. The method of claim 1 wherein the cured epoxy resin composition has a Tg of at least about 270° F. (132.2° C.).

17. A reinforced pipe formed by the method of claim 1.

18. A system for reinforcing an inner surface of a pipe comprising:
a curable epoxy resin composition comprising an epoxy phenolic resin;
a curing agent comprising a diamine;
and a carbon fiber material configured for application to the inner surface of a pipe;
wherein the curable epoxy resin composition and the curing agent are present in a ratio that, when combined, will form a cured epoxy resin composition having a Tg of at least about 250° F. (121.1° C.).

19. A system for reinforcing an outer surface of a pipe comprising:
a curable epoxy resin composition comprising an epoxy phenolic resin;
a curing agent comprising a diamine;
and a carbon fiber material configured for application to the outer surface of a pipe;
wherein the curable epoxy resin composition and the curing agent are present in a ratio that, when combined, will form a cured epoxy resin composition having a Tg of at least about 250° F. (121.1° C.).
